(19) United States
(12) Patent Application Publication
(10) Pub. No.: US 2018/0143960 A1
(43) Pub. Date: May 24, 2018

(54) Modifying Tabular Data to be Rendered on a Display Device

(71) Applicant: International Business Machines Corporation, Armonk, NY (US)

(72) Inventors: Lisa Seacat DeLuca, Baltimore, MD (US); Dana L. Price, Surf City, NC (US); Aaron J. Quirk, Cary, NC (US); Shelbee D. Smith-Eigenbrode, Thornton, CO (US)

(21) Appl. No.: 15/355,367

(22) Filed: Nov. 18, 2016

(51) Int. Cl. G06F 17/24; G06F 17/21

(52) U.S. Cl. CPC G06F 17/245; G06F 17/211

(57) ABSTRACT

An approach is disclosed that identifies a width of an area on a display screen used to display a rows of text. The approach determining a level of similarity that exists between the text found in the rows of text and that this level of similarity exceeds a threshold. Responsively, the approach identifies a short form that corresponds to similar text found in the rows of text and modifies the rows of text by substituting the similar text with the identified short form. The modified rows of text are then displayed in the area on the display screen.

### BACKGROUND

When viewing lists of data or tables in columns, it can be frustrating for a user when the substance of the message is not clear in the visible column width. This becomes much more evident when accessing data across desktop and mobile devices and the impact upon the user is dependent on the device orientation, the size of the available window/screen, and the design of the application or web site. For example, when viewing emails sent and received about a particular subject, there might be substantially similar text that is displayed on the available viewing area, with important and distinguishing data not being displayed. In this situation, the user is often forced to scroll the display or view each of the emails individually in order to view the important and distinguishing information, negatively impacting the performance of the user.

### SUMMARY

An approach is disclosed that identifies a width of an area on a display screen used to display multiple rows of text. The approach determines a level of similarity that exists between the text found in the rows of text and that this level of similarity exceeds a threshold. Responsively, the approach identifies a short form that corresponds to similar text found in the rows of text and modifies the rows of text by substituting the similar text with the identified short form. The modified rows of text are then displayed in the area on the display screen.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a screen diagram depicting a display populated by similar components followed by resulting display that uses a differentiation process to analyze similar components in viewable rows and columns;

FIG. 4 is a flowchart depicting setup processing performed by the user to set preferences used by the differentiation process to analyze similar components in viewable rows and columns;

FIG. 5 is a flowchart depicting the processing performed by the differentiation process that analyzes similar components in viewable rows and columns; and

FIG. 6 is a flowchart depicting the process that identifies similar text and substitutes similar text with short forms of the text.

### DETAILED DESCRIPTION

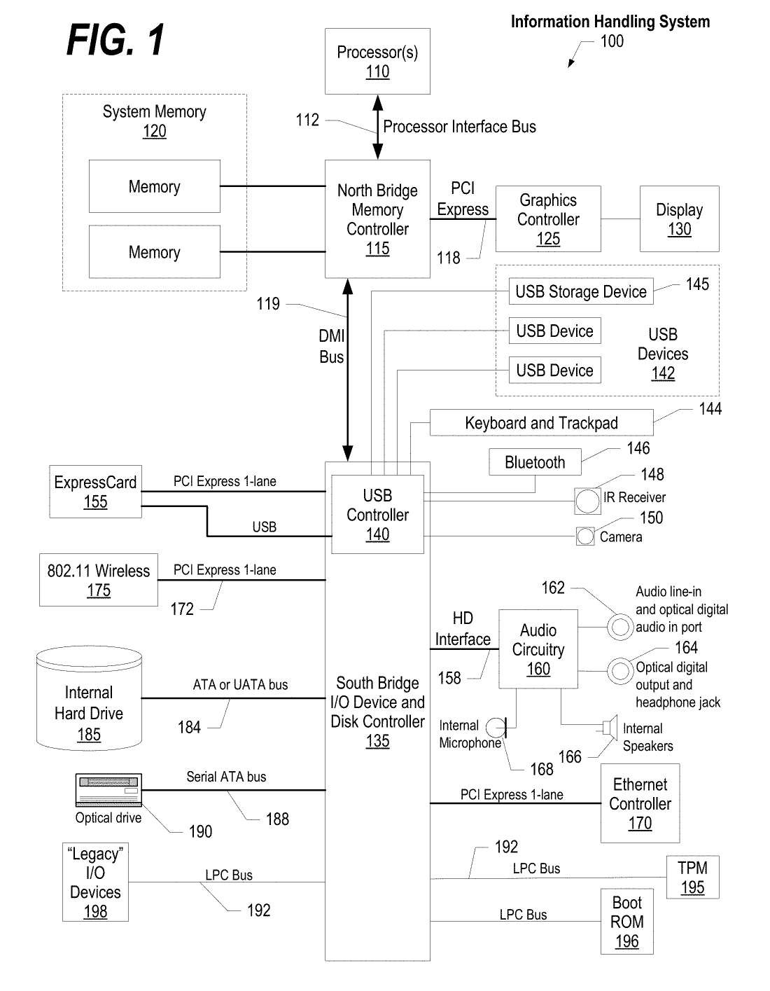

FIGS. 1-6 show an approach that implements a differentiation process to analyze similar components in viewable rows and columns. The approach identifies similar content in list data and returns a more meaningful list that is displayed to the user that is responsive to the view of the data with items containing similar data being differentiated from other list data in the viewable rows and columns. The approach provides an enhanced user experience across varying devices, browsers, windows. In addition, the approach provides for less user modification to the list items in terms of selecting (e.g., clicking, etc.) on list items, column reorganization, and modification of window sizes to view and consume data.

The approach can be implemented in a client-server embodiment with the server returning the list data that is displayed to the user, or the approach can be implemented as a client-based solution with client processing determining the list data that is displayed. One possible embodiment that utilizes the approach provided herein is set forth below. In addition, rather than substituting a short form for similar text found in a column of data, the approach can simply delete the similar text from the displayed view. In one embodiment, this is accomplished by noting that the similar text should be deleted in a configuration setting, such as by leaving the short form field blank, set to null, or set to some other special code.

In this embodiment, the system has a default view of the data (email, messages, contact information, etc.). The system can provide an optional view that modifies the view of the data to optimize the consumption of the data, such as providing an alternate view that implements the solution, and toggling an existing view between the default and the alternate view via a button, gesture, command, etc. The user can specify the shortening methods that are used by the approach, such as short forms of abbreviations, whether certain words are removed, whether text is rearranged and, if so how, and the like.

The approach analyzes data elements and the width of the view (in either characters or pixels). If the length of the data element is longer than the available column width in the current view, then the data element is shortened to fit in the column (e.g., using the least amount of modification possible to fit in the viewing area, etc.) via one or more methods. These methods can include using common well-known abbreviations and acronyms, removal of extra spaces, punctuation, etc., utilizing text messaging shortcuts, using existing text shortening tools, using existing domain-name shortening tools, and reordering the elements displayed where abbreviations do not shorten the data element enough to be viewed in the visible area.

In one embodiment, if the preferred/allowed shortening still does not shorten the data element enough to fit entirely in the column or viewing area, the approach compares the data elements to other elements in the list with each element being modified in a way to ensure differentiation in the view. The approach can then display the list content with modifications, as needed to fit in the available viewing area. In one embodiment, the user can optionally toggle back and forth between the original view and the view that differentiates data based on the similarities found in the data.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium does not include a computer readable signal medium.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

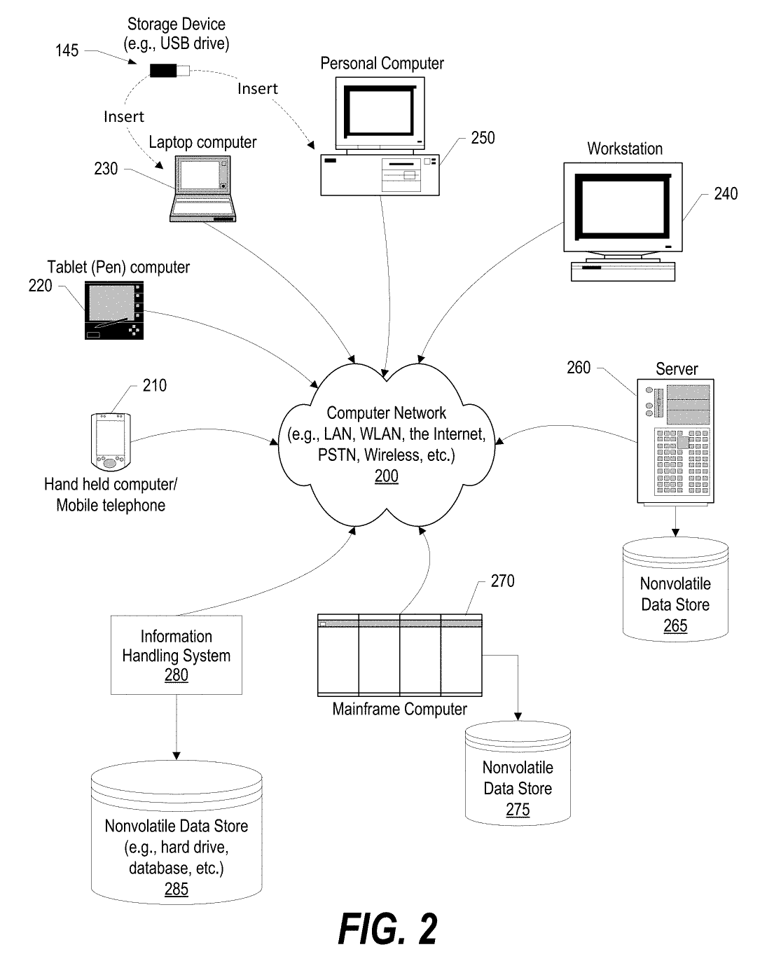

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

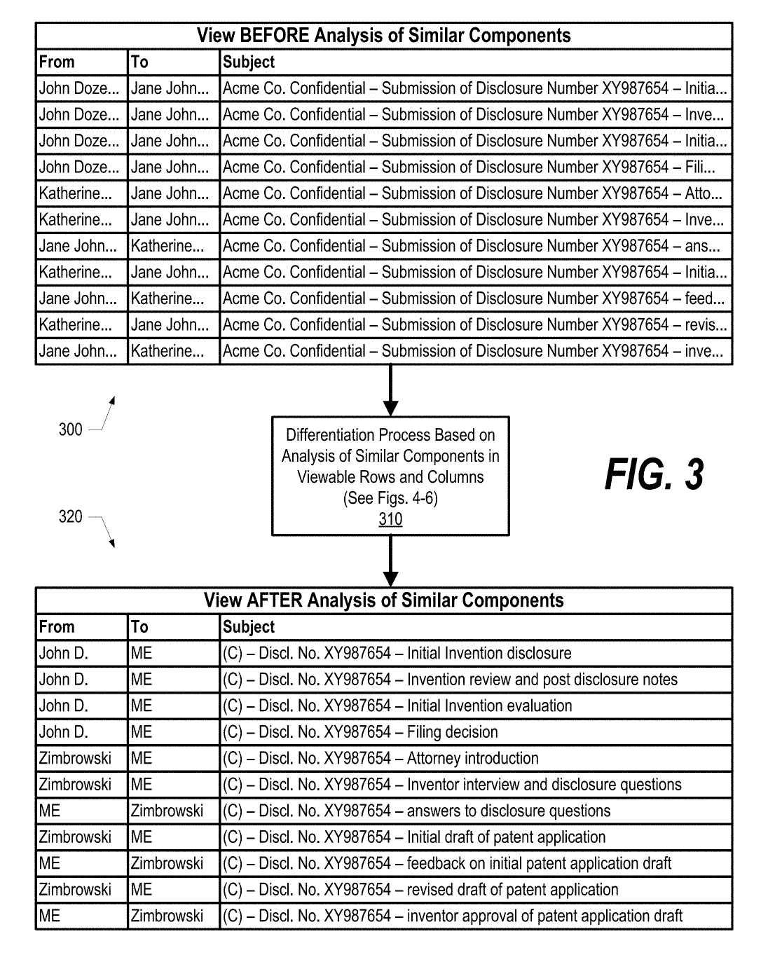

FIG. 3 is a screen diagram depicting a display populated by similar components followed by resulting display that uses a differentiation process to analyze similar components in viewable rows and columns. Screen display 300 shows a view of rows of data in various columns, such as might be found in an electronic mail (email) application. The columns show the sender of the data (the “from” column), the person to whom the message was addressed (the “to” column”), and a subject of the message (the “subject” column). However, as depicted, much of the data being displayed is similar to other the text found in other rows, so that the subject of any individual row includes a substantial amount of similar text, such as the message being confidential and concerning a particular submission, such as might be found in an invention submission system. The more meaningful subject data does not appear in display screen 300 as the information does not fit in the width of the allocated screen area provided to show the subject.

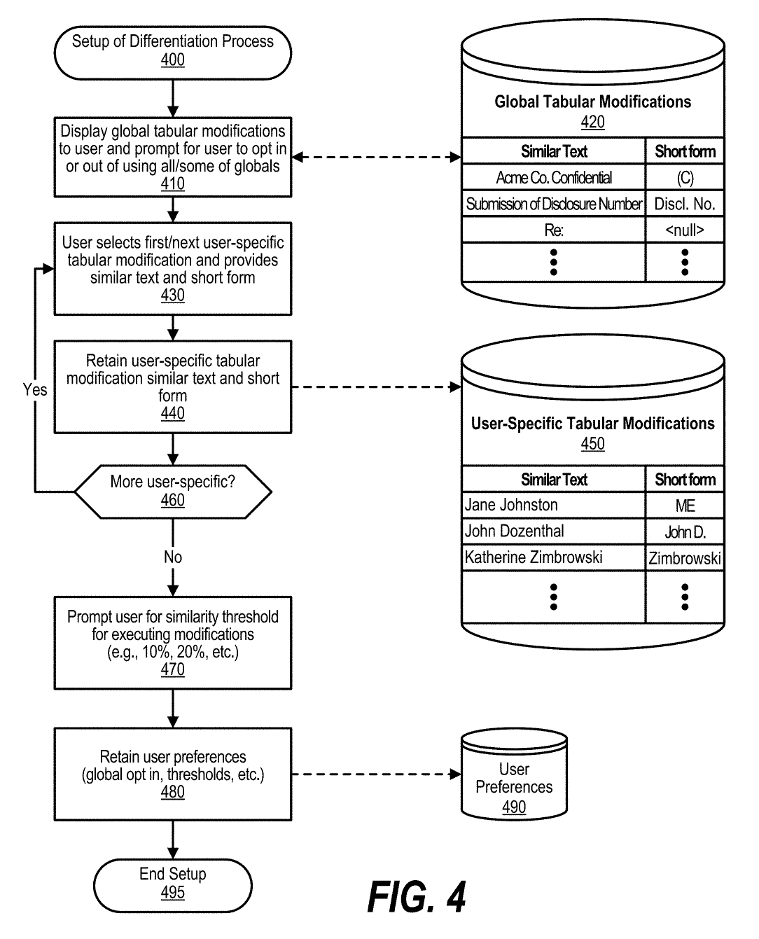

Differentiation process 310 is performed automatically when a user wishes to view columns and rows of text with data that might contain similar text. FIGS. 4-6 provide further details regarding the differentiation process. Screen display 320 shows the result of the differentiation process with short forms being substituted for similar text. In the “from” and “to” columns, names of senders and recipients have been shortened to a form that better fits in the screen area provided for these fields. In addition, in the “subject” column, multiple sets of similar text have been replaced with short forms of text so that the more interesting and meaningful text found in the subject of the various emails. For example, similar text of “Acme Co. Confidential” have been replaced with short form of “(C)” and similar text of “Submission of Disclosure Number” have been replaced with short form of “Discl. No.” In this manner, using the approach more fully described in FIGS. 4-6, the repeated similar text found in the original set of rows and columns is replaced with a more meaningful and more interesting representation that better fits in the screen area allocated for the various columns of text. In addition, rather than substituting a short form for similar text found in a column of data, the process can simply delete the similar text from the displayed view. In one embodiment, this is accomplished by noting that the similar text should be deleted in a configuration setting, such as by leaving the short form field blank, set to null, or set to some other special code.

FIG. 4 is a flowchart depicting setup processing performed by the user to set preferences used by the differentiation process to analyze similar components in viewable rows and columns. FIG. 4 processing commences at 400 and shows the steps taken by a process that allows the user to setup preferences used by the Differentiation Process. At step 410, the process displays global tabular modifications to the user and prompts the user to opt in or out of using all/some of the set of default values. The global tabular modifications are retrieved from data store 420 and include “default” settings. In the default settings shown, when similar text of “Acme Co. Confidential” is found, it will be substituted with short form of “C”, and when similar text of “Submission of Disclosure Number” is found, it will be substituted with short form of “Discl. No.” The user can select or deselect any of the defaults (e.g., select the short form substitution for “Acme Co. Confidential,” but opt out of the short form substitution for “Submission of Disclosure Number, etc.). In addition, rather than substituting a short form for similar text found in a column of data, the approach can simply delete the similar text from the displayed view. In one embodiment, this is accomplished by noting that the similar text should be deleted in a configuration setting, such as by leaving the short form field blank, set to null, or set to some other special code. In the example shown in data store 420, common text of “Re:” is replaced with nothing, or essentially deleted, as noted by the corresponding short form being set to “<null>”.

At step 430, the user selects the first user-specific tabular modification and provides the similar text and the short form to use as the substitution. In the example shown, when similar text of “Jane Johnston” is found, it is substituted with a short form of “ME” (indicating that Jane Johnston is the user). Similar substitutions are made for other selections made by the user and stored in data store 450. At step 440, the process retains the selected similar text and short form in user-specific tabular modification data store 450. The process determines as to whether the user wishes to configure additional user-specific sets of similar text and short forms (decision 460). If the user wishes to configure additional user-specific sets of similar text and short forms, then decision 460 branches to the ‘yes’ branch which loops back to step 430 to repeat the process described above. This looping continues until the user no longer wishes to configure additional user-specific sets of similar text and short forms, at which point decision 460 branches to the ‘no’ branch exiting the loop.

At step 470, the process prompts user for similarity threshold for executing modifications (e.g., 10%, 20%, etc.). This threshold can be established so that the similar text is only substituted with the corresponding short form text when the amount of similar text exceeds the threshold provided by the user. For example, if a 10% threshold is established, then “Acme Co. Confidential” is only replaced with the short form of “(C)” when ten percent of the rows have this similar data. At step 480, the process retains the user preferences set by the user in data store 490. The preferences saved include the global opt in/opt out preferences, the user-specific tabular modifications, and the similarity threshold level. FIG. 4 processing thereafter ends at 495.

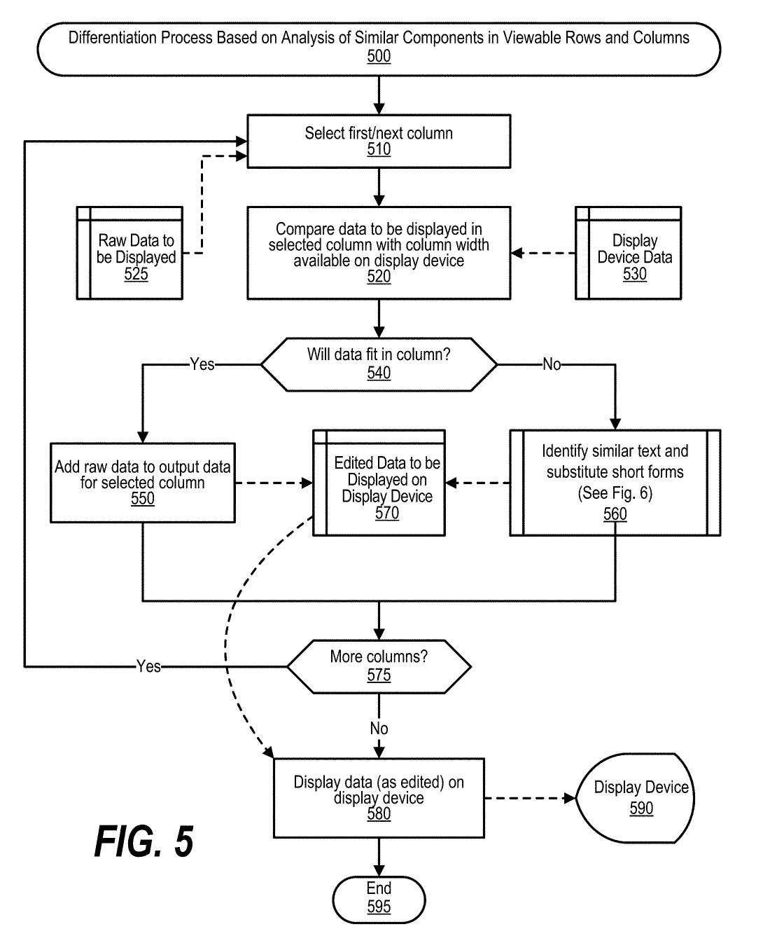

FIG. 5 is a flowchart depicting the processing performed by the differentiation process that analyzes similar components in viewable rows and columns. FIG. 5 processing commences at 500 and shows the steps taken by a process that performs the differentiation process based on an analysis of similar textual components found in viewable rows and columns. At step 510, the process selects the first column of data to be displayed from memory area 525. At step 520, the process compares the data that is to be displayed in the selected column with the column width that is available on the display device. The display device information is retrieved from memory area 530.

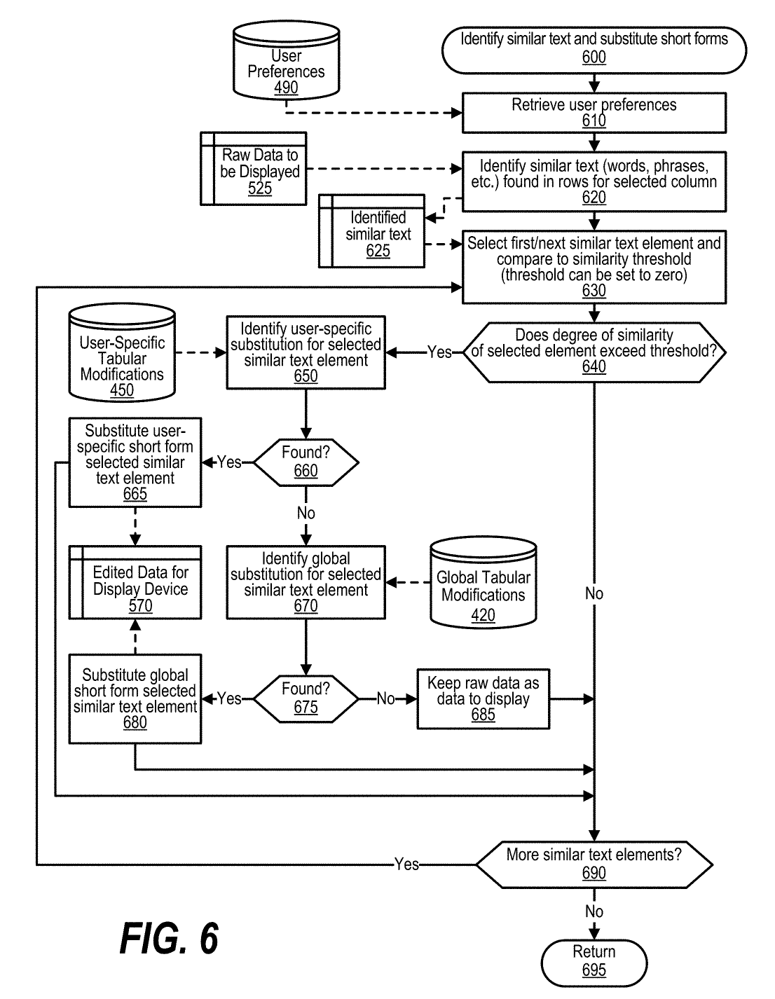

The process determines as to whether the data that is to be displayed in the rows will fit in the available width allocated on the display screen as determined by the width of the column (decision 540). If the data that is to be displayed in the rows will fit in the available width allocated on the display screen, then decision 540 branches to the ‘yes’ branch to perform step 550. On the other hand, if the data that is to be displayed in the rows will not fit in the available width allocated on the display screen, then decision 540 branches to the ‘no’ branch whereupon predefined process 560 is performed. At step 550, the process adds the raw data that was retrieved from memory area 525 to the output data for the selected column. The output data is stored in memory area 570. At predefined process 560, the process performs the identify similar text and substitute short forms routine (see FIG. 6 and corresponding text for processing details). This routine identifies similar text in the data that is to be displayed in the column and, if the amount of similarity exceeds a threshold, substitutes short forms for sets of similar text, such as substituting a “(C)” for each occurrence of “Acme Co. Confidential.” The modified text for the rows of data to be displayed in the selected column are added to output memory area 570.

The process then determines as to whether there are more columns of data to be displayed on the display screen (decision 575). If there are more columns of data to be displayed on the display screen, then decision 575 branches to the ‘yes’ branch which loops back to step 510 to select and process the next column as described above. This looping continues until there are no more columns of data to process, at which point decision 575 branches to the ‘no’ branch exiting the loop. At step 580, the process displays the resulting data, as modified due to the identification of similar sets of text, on display device 590. FIG. 5 processing thereafter ends at 595.

FIG. 6 is a flowchart depicting the process that identifies similar text and substitutes similar text with short forms of the text. FIG. 6 processing commences at 600 and shows the steps taken by a process that identifies similar text among rows of data and, when appropriate, substitutes short forms of text for the sets of similar text. At step 610, the process retrieves user preferences from data store 490. At step 620, the process identifies similar text, such as words, phrases, or the like, that are found in the rows of text destined for the selected column. The raw text is retrieved from memory area 525 and the identified similar text is stored in memory area 625.

At step 630, the process selects the first set of similar text and compares the amount of similar text that was identified to the similarity threshold that was set by the user to determine when substitutions should be performed. In one embodiment, the threshold can be set to zero. The process determines as to whether the amount of similar text found exceeds the threshold that was set by the user (decision 640). If the amount of similar text found exceeds the threshold that was set by the user, then decision 640 branches to the ‘yes’ branch to perform steps 650 through 685. On the other hand, if the amount of similar text found does not exceed the threshold that was set by the user, then decision 640 branches to the ‘no’ branch bypassing steps 650 through 685.

Steps 650 through 685 are performed when the amount of similar text found exceeds the threshold that was set by the user. At step 650, the process identifies user-specific substitution for the selected set of similar text from data store 450. The process determines as to whether a user-specified short form substitution was found (decision 660). If a user-specified short form substitution was found, then decision 660 branches to the ‘yes’ branch to perform step 665. On the other hand, if a user-specified short form substitution was not found, then decision 660 branches to the ‘no’ branch to perform step 670. At step 665, the process substitutes a user-specified short form for the selected set of similar text. As previously described, the similar text can be deleted, rather than replaced with a short form text. In one embodiment, this is accomplished by the short form being set to blank, null, or some special character. This substitution is stored in memory area 570. At step 670, the process identifies a global, or default, substitution short form for the selected similar text. The default short form substitutions are retrieved from data store 420. The process determines as to whether a default short form substitution was found (decision 675). If a default short form substitution was found, then decision 660 branches to the ‘yes’ branch to perform step 680 whereupon the process substitutes a default short form for the selected set of similar text. Again, the short form can indicate that the similar text is to be deleted rather than be replaced with a shorter set of text. On the other hand, if a default short form substitution was not found, then decision 660 branches to the ‘no’ branch whereupon, at step 685, the similar text is retained.

The process next determines as to whether there are more sets of similar text to process (decision 690). If there are more sets of similar text to process, then decision 690 branches to the ‘yes’ branch which loops back to step 630 to select and process the next set of similar text as described above. This looping continues until all identified sets of similar text have been processed, at which point decision 690 branches to the ‘no’ branch exiting the loop and processing returns to the calling routine (see FIG. 5) at 695.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method comprising:
identifying a width of an area on a display screen used to display a first plurality of rows of text;
in response to determining that a level of similarity between the text of the plurality of rows exceeds a threshold:
identifying a first short form that corresponds to a first set of similar text found in the first plurality of rows of text;
modifying the first plurality of rows of text by substituting the first set of similar text with the identified short form, the modifying resulting in a second plurality of rows of text; and
displaying the second plurality of rows of text in the area on the display screen.

2. The method of claim 1 wherein the identifying, modifying, and displaying are performed in response to the determination that the level of similarity exceeds the threshold and in response to determining that a width of the first plurality of rows of text exceeds the width of the area on the display screen.

3. The method of claim 1 further comprising:
in response to determining that a width of the second plurality of rows of text exceeds the width of the area on the display screen:
identifying a subsequent short form that corresponds to a subsequent set of similar text found in the first plurality of rows of text;
further modifying the first plurality of rows of text by substituting the subsequent set of similar text with the identified subsequent short form, the modifying resulting in one or more further pluralities of rows of text; and
displaying a selected one of the further plurality of rows of text in the area on the display screen in response to the selected one of the further pluralities of rows having a width that fits inside the width of the area on the display screen.

4. The method of claim 1 further comprising:
searching a data store that comprises a plurality of short forms and a corresponding plurality of similar text, wherein each of the short forms corresponds to one of the plurality of similar text, and wherein at least one of the short forms is a setting that indicates that the corresponding similar text is to be deleted; and
identifying the first short term based on comparing the first set of similar text with the plurality of similar text from the data store.

5. The method of claim 1 further comprising:
searching a first data store that comprises a plurality of user-specified short forms and a corresponding plurality of user-specified similar text, wherein each of the user-specified short forms corresponds to one of the plurality of user-specified similar text; and
identifying the first short term based on comparing the first set of similar text with the plurality of user-specified similar text from the data store.

6. The method of claim 1 further comprising:
searching a first data store that comprises a plurality of default short forms and a corresponding plurality of default similar text, wherein each of the user-specified short forms corresponds to one of the plurality of user-specified similar text; and
identifying the first short term based on comparing the first set of similar text with the plurality of default similar text from the data store.

7. The method of claim 1 further comprising:
searching a first data store that comprises a plurality of user-specified short forms and a corresponding plurality of user-specified similar text, wherein each of the user-specified short forms corresponds to one of the plurality of user-specified similar text;
in response to the searching finding the first set of similar text with the plurality of user-specified similar text from the data store:
identifying the first short term based on comparing the first set of similar text with the plurality of user-specified similar text from the data store; and
in response to the searching failing to find the first set of similar text with the plurality of user-specified similar text from the data store:
searching a second data store that comprises a plurality of default short forms and a corresponding plurality of default similar text, wherein each of the user-specified short forms corresponds to one of the plurality of user-specified similar text; and
identifying the first short term based on comparing the first set of similar text with the plurality of default similar text from the data store.

8. An information handling system comprising:
one or more processors;
a display screen accessible by at least one of the processors;
a memory coupled to at least one of the processors; and
a set of instructions stored in the memory and executed by at least one of the processors that perform actions comprising:
identifying a width of an area on the display screen used to display a first plurality of rows of text;
in response to determining that a level of similarity between the text of the plurality of rows exceeds a threshold:
identifying a first short form that corresponds to a first set of similar text found in the first plurality of rows of text;
modifying the first plurality of rows of text by substituting the first set of similar text with the identified short form, the modifying resulting in a second plurality of rows of text; and
displaying the second plurality of rows of text in the area on the display screen.

9. The information handling system of claim 8 wherein the identifying, modifying, and displaying are performed in response to the determination that the level of similarity exceeds the threshold and in response to determining that a width of the first plurality of rows of text exceeds the width of the area on the display screen.

10. The information handling system of claim 8 wherein the actions further comprise:
in response to determining that a width of the second plurality of rows of text exceeds the width of the area on the display screen:
identifying a subsequent short form that corresponds to a subsequent set of similar text found in the first plurality of rows of text;
further modifying the first plurality of rows of text by substituting the subsequent set of similar text with the identified subsequent short form, the modifying resulting in one or more further pluralities of rows of text; and
displaying a selected one of the further plurality of rows of text in the area on the display screen in response to the selected one of the further pluralities of rows having a width that fits inside the width of the area on the display screen.

11. The information handling system of claim 8 wherein the actions further comprise:
searching a data store that comprises a plurality of short forms and a corresponding plurality of similar text, wherein each of the short forms corresponds to one of the plurality of similar text, and wherein at least one of the short forms is a setting that indicates that the corresponding similar text is to be deleted; and
identifying the first short term based on comparing the first set of similar text with the plurality of similar text from the data store.

12. The information handling system of claim 8 wherein the actions further comprise:
searching a first data store that comprises a plurality of user-specified short forms and a corresponding plurality of user-specified similar text, wherein each of the user-specified short forms corresponds to one of the plurality of user-specified similar text; and
identifying the first short term based on comparing the first set of similar text with the plurality of user-specified similar text from the data store.

13. The information handling system of claim 8 wherein the actions further comprise:
searching a first data store that comprises a plurality of default short forms and a corresponding plurality of default similar text, wherein each of the user-specified short forms corresponds to one of the plurality of user-specified similar text; and
identifying the first short term based on comparing the first set of similar text with the plurality of default similar text from the data store.

14. The information handling system of claim 8 wherein the actions further comprise:
searching a first data store that comprises a plurality of user-specified short forms and a corresponding plurality of user-specified similar text, wherein each of the user-specified short forms corresponds to one of the plurality of user-specified similar text;
in response to the searching finding the first set of similar text with the plurality of user-specified similar text from the data store:
identifying the first short term based on comparing the first set of similar text with the plurality of user-specified similar text from the data store; and
in response to the searching failing to find the first set of similar text with the plurality of user-specified similar text from the data store:
searching a second data store that comprises a plurality of default short forms and a corresponding plurality of default similar text, wherein each of the user-specified short forms corresponds to one of the plurality of user-specified similar text; and
identifying the first short term based on comparing the first set of similar text with the plurality of default similar text from the data store.

15. A computer program product comprising:
a computer readable storage medium comprising a set of computer instructions, the computer instructions effective to perform actions comprising:
identifying a width of an area on a display screen used to display a first plurality of rows of text;
in response to determining that a level of similarity between the text of the plurality of rows exceeds a threshold:
identifying a first short form that corresponds to a first set of similar text found in the first plurality of rows of text;
modifying the first plurality of rows of text by substituting the first set of similar text with the identified short form, the modifying resulting in a second plurality of rows of text; and
displaying the second plurality of rows of text in the area on the display screen.

16. The computer program product of claim 15 wherein the identifying, modifying, and displaying are performed in response to the determination that the level of similarity exceeds the threshold and in response to determining that a width of the first plurality of rows of text exceeds the width of the area on the display screen.

17. The computer program product of claim 15 wherein the actions further comprise:
in response to determining that a width of the second plurality of rows of text exceeds the width of the area on the display screen:
identifying a subsequent short form that corresponds to a subsequent set of similar text found in the first plurality of rows of text;
further modifying the first plurality of rows of text by substituting the subsequent set of similar text with the identified subsequent short form, the modifying resulting in one or more further pluralities of rows of text; and
displaying a selected one of the further plurality of rows of text in the area on the display screen in response to the selected one of the further pluralities of rows having a width that fits inside the width of the area on the display screen.

18. The computer program product of claim 15 wherein the actions further comprise:
searching a data store that comprises a plurality of short forms and a corresponding plurality of similar text, wherein each of the short forms corresponds to one of the plurality of similar text, and wherein at least one of the short forms is a setting that indicates that the corresponding similar text is to be deleted; and
identifying the first short term based on comparing the first set of similar text with the plurality of similar text from the data store.

19. The computer program product of claim 15 wherein the actions further comprise:
searching a first data store that comprises a plurality of user-specified short forms and a corresponding plurality of user-specified similar text, wherein each of the user-specified short forms corresponds to one of the plurality of user-specified similar text; and
identifying the first short term based on comparing the first set of similar text with the plurality of user-specified similar text from the data store.

20. The computer program product of claim 15 wherein the actions further comprise:
searching a first data store that comprises a plurality of user-specified short forms and a corresponding plurality of user-specified similar text, wherein each of the user-specified short forms corresponds to one of the plurality of user-specified similar text;
in response to the searching finding the first set of similar text with the plurality of user-specified similar text from the data store:
identifying the first short term based on comparing the first set of similar text with the plurality of user-specified similar text from the data store; and
in response to the searching failing to find the first set of similar text with the plurality of user-specified similar text from the data store:
searching a second data store that comprises a plurality of default short forms and a corresponding plurality of default similar text, wherein each of the user-specified short forms corresponds to one of the plurality of user-specified similar text; and
identifying the first short term based on comparing the first set of similar text with the plurality of default similar text from the data store.
